(19) United States
(12) Patent Application Publication
(10) Pub. No.: US 2024/0003337 A1
(43) Pub. Date: Jan. 4, 2024

(54) WIND TURBINE ROTOR BLADE AND WIND TURBINE

(71) Applicant: Wobben Properties GmbH, Aurich (DE)

(72) Inventors: Muhanad Mahmoud, Aurich (DE); Jochen Stemberg, Aurich (DE); Hussam Daboul, Südbrookmerland (DE)

(21) Appl. No.: 18/345,795

(22) Filed: Jun. 30, 2023

(30) Foreign Application Priority Data
Jul. 4, 2022 (EP) 22182753.8

(51) Int. Cl. F03D 80/40; F03D 1/06

(52) U.S. Cl. CPC F03D 80/40; F03D 1/0675; F05B 2240/30; F05B 2260/60

(57) ABSTRACT

A wind turbine rotor blade, with a length, a rotor blade root, a rotor blade tip, a pressure side, a suction side, a leading edge, a trailing edge, and an air guide for heated air to guide heated air inside of the rotor blade and along a longitudinal direction of the rotor blade from the rotor blade root in the direction of the rotor blade tip. The wind turbine rotor blade additionally comprises at least one aerodynamic mixer in the area of the air guide. The invention further relates to a wind turbine with at least one wind turbine rotor blade.

### BACKGROUND

### Technical Field

The present invention relates to a wind turbine rotor blade and a wind turbine.

### Description of the Related Art

Since rotor blades are exposed to all weather conditions unprotected, the rotor blades can become iced at specific temperatures. A rotor blade heater can be used to prevent this. Either a heater can be provided outside on the rotor blade, or heated air can be made available inside of the rotor blade. For example, this can take place by means of a heating register, which generates hot air that is then blown into the interior of the rotor blade.

WO 2017/021350 A1 shows a wind turbine rotor blade with a rotor blade root area and a rotor blade tip area, as well as a rotor blade heater. At least one web is further provided along a longitudinal axis of the rotor blade. A deflection unit in the form of a bar drop can be provided on the web, so as to reduce air turbulence in the deflection process.

WO 2018/211055 shows a wind turbine rotor blade with a rotor blade heater. The rotor blade has a web and a deflection unit in the area of the rotor blade tip for deflecting heated air.

### BRIEF SUMMARY

Provided is a wind turbine rotor blade that enables an improved heating of the rotor blade.

Provided is a wind turbine rotor blade with a rotor blade root, a rotor blade tip, a pressure side, a suction side, a leading edge, and a trailing edge. The rotor blade has a longitudinal direction. A rotor blade heater is used to generate hot air, which is then blown into the interior of the rotor blade. At least one static or passive aerodynamic mixer is provided in the air duct inside of the rotor blade. The mixer causes turbulence in the air flowing through it and/or an at least local increase in the flow rate. As a result of the mixer, the air masses with varying temperatures (hot air in the middle of the air flow and colder air toward the rotor blade exterior) mix together better.

According to an aspect of the disclosure, the static aerodynamic mixer can be configured like an aerodynamic mixer, a stator vane or baffle plate. Alternatively or additionally thereto, the mixer can take the form of a helical profiling (e.g., spiral grooves can be provided in a tube wall) on the inner walls of the air duct.

The aerodynamically active elements of the mixer convert a uniform air flow at least partially into an air flow with a swirl added to it.

According to an aspect of the disclosure, at least one web is provided between the pressure side and the suction side along the longitudinal direction of the rotor blade. The air heated by the rotor blade heater can be blown along the web in the direction of the rotor blade tip, where it is deflected, so that the heated air on the other side of the web can flow back from the rotor blade tip area to the rotor blade root area. An aerodynamic mixer can be provided along a web.

The static or passive aerodynamic mixer optionally has no active elements that would have to be driven to mix the air flowing through.

According to an aspect, one side of the aerodynamic mixer can be coupled to the rotor blade inner wall or to a web.

Additional embodiments of the disclosure are the subject of the subclaims.

### BRIEF DESCRIPTION OF THE SEVERAL VIEWS OF THE DRAWINGS

Advantages and exemplary embodiments of the invention will be described in more detail below with reference to the drawing.

FIG. 1 shows a schematic view of a wind turbine according to the disclosure,

FIG. 2 shows a schematic, sectional view of the rotor blade of the wind turbine on FIG. 1 according to a first exemplary embodiment,

FIG. 3 shows a schematic, sectional view of the rotor blade of the wind turbine on FIG. 1 according to a second exemplary embodiment,

FIG. 4A shows a schematic, sectional view of an air duct for a rotor blade according to prior art,

FIG. 4B shows a schematic, sectional view of an air duct for a rotor blade according to an exemplary embodiment of the disclosure,

FIG. 5 shows a schematic view of an air flow in an air duct for a rotor blade according to an exemplary embodiment of the disclosure,

FIG. 6 shows a schematic view of a mixer according to an exemplary embodiment of the disclosure,

FIG. 7 shows a schematic view of a mixer according to a sixth exemplary embodiment,

FIG. 8 shows a schematic view of a mixer according to a seventh exemplary embodiment,

FIG. 9 shows a schematic view of a mixer for a rotor blade according to an eighth exemplary embodiment,

FIG. 10 shows a schematic, sectional view of a rotor blade according to a ninth exemplary embodiment,

FIG. 11 shows a schematic, sectional view of a rotor blade according to a tenth exemplary embodiment, and

FIG. 12 shows a schematic, sectional view of a rotor blade according to an eleventh exemplary embodiment.

### DETAILED DESCRIPTION

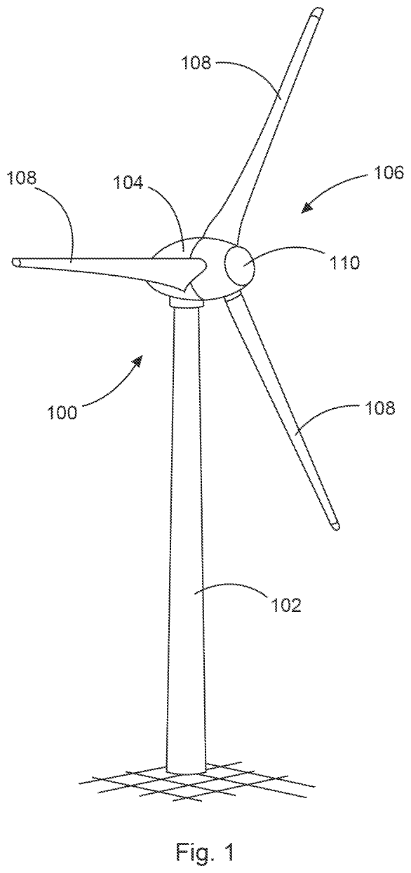

FIG. 1 shows a schematic view of a wind turbine according to the disclosure. The wind turbine 100 has a tower 102 and a nacelle 104 on the tower 102. An aerodynamic rotor 106 with three rotor blades 200 and a spinner 110 is provided on the nacelle 104. During operation of the wind turbine, the aerodynamic rotor 106 is made to rotate by the wind, and thereby also turns a rotor or runner of a generator, which is directly or indirectly coupled with the aerodynamic rotor 106. The electric generator is arranged in the nacelle, and generates electric energy. The pitch angles of the rotor blades 200 can be changed by pitch motors on the rotor blade roots 210 of the respective rotor blades 200.

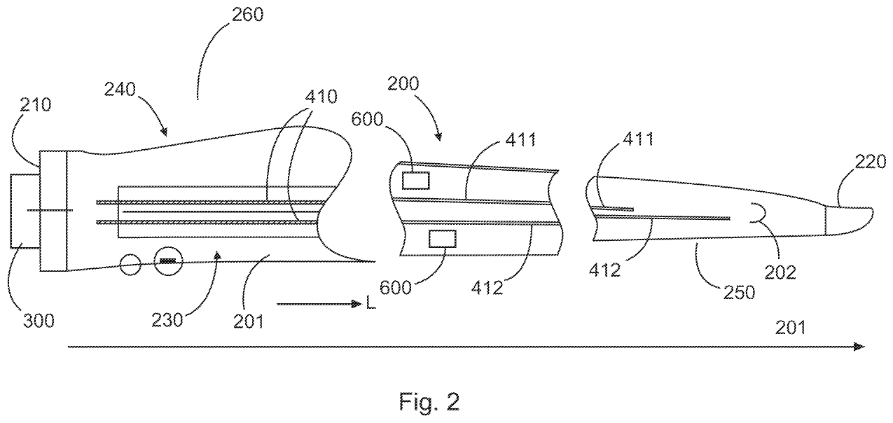

FIG. 2 shows a schematic, sectional view of the rotor blade of the wind turbine on FIG. 1 according to a first exemplary embodiment. The rotor blade 200 has a length 201, a rotor blade root 210, a rotor blade tip 220, a leading edge 230, a trailing edge 240, a pressure side 250, and a section side 260. Provided inside of the rotor blade 200 is an air guide 400, for example which can be designed like a web 410. A rotor blade heater 300 can be provided in the area of the rotor blade root 210. The rotor blade heater 300 can have a fan and a heating unit, and generate hot air that can be guided into the interior of the rotor blade 200.

At least one web 410, 411, 412 extends along a longitudinal direction L of the rotor blade 200 inside of the rotor blade, and is part of the air guide 400 or already present for other reasons, with the air guide 400 having only a secondary function. More than one web can optionally be provided.

The air heated by the rotor blade heater 300 can be guided along the web 411 as part of the air guide 400 in the direction of the rotor blade tip 220, and then be deflected in the area of the rotor blade tip 220. To this end, a deflection section 202 can be present in the area of the rotor blade tip 220. The rotor blade tip 220 can optionally be at least partially hollow in design, so that a portion of the heated air can flow through the rotor blade tip 220, in order to also deice the rotor blade tip 220.

The heated air can be generated by means of the rotor blade heater 300 either in the rotor blade root area, by virtue of a heating unit heating the air, or the heated air is supplied to the rotor blade 200 in the area of the rotor blade root 210.

At least one aerodynamic mixer 600 can be provided along the length L of the rotor blade 200 in the air guide. The mixer 600 can be used to add a swirl to the air flow of the rotor blade heater, or to swirl the air flow. This is advantageous, since it can lead to an improved mixing of the air flow.

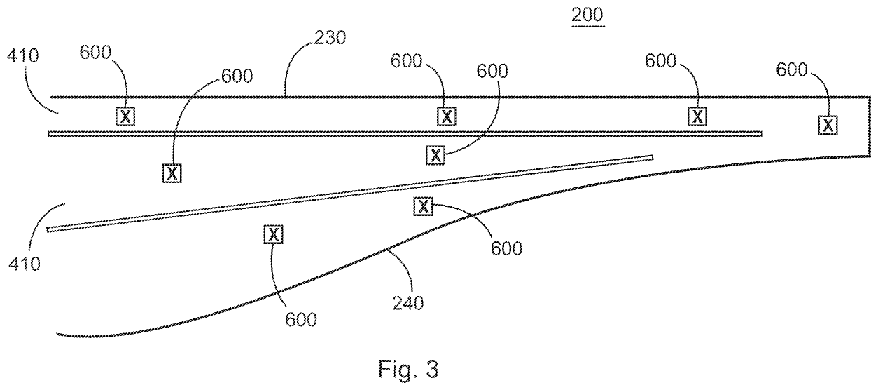

FIG. 3 shows a schematic view of a rotor blade according to a second exemplary embodiment. The rotor blade 200 has a rotor blade root 210, a rotor blade tip 220, a leading edge 230, and a trailing edge 240. Provided inside of the rotor blade is at least one web 410, which extends from the area of the rotor blade root 210 into the area of the rotor blade tip 220. The rotor blade 200 has at least one aerodynamic mixer 600. This type of mixer can be arranged along a length of the webs 410.

The mixer is used to change the air flow of the rotor blade heater. In particular, the mixer 600 can be used to add a swirl to the air flow. Alternatively or additionally thereto, the mixer can be used to influence the flow rate of the air flow.

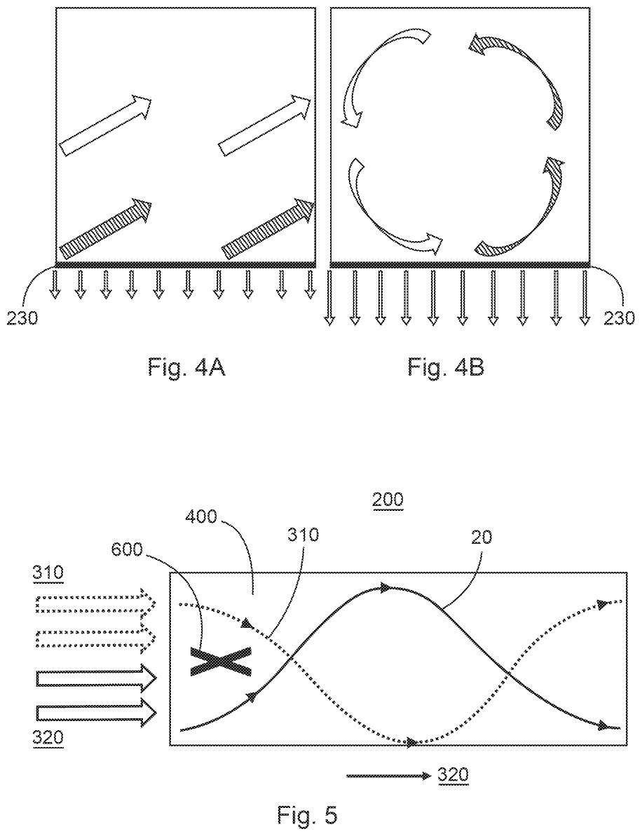

FIG. 4A shows a schematic view of an air guide section of a rotor blade according to prior art. In particular, FIG. 4A depicts a cutout of the leading edge 230. In the area of the leading edge 230, a heat exchange takes place between the heated air, for example which is made available by the rotor blade heater 300, and the cold surface of the leading edge 230. This can result in different air layers with different temperatures being present. A first air flow (cold air) can arise at the rotor blade leading edge, and another air flow (hot air) can be present in a section lying thereover. This can result in an exchange between the hot air and the cold air taking place only conditionally. As a consequence, it might happen that the heat contained in the heated air flow is not transferred to the rotor blade leading edge 230.

FIG. 4B shows a schematic, sectional view of an air guide in a rotor blade according to a third exemplary embodiment. This type of rotor blade is provided with at least one mixer in the area of the air guide. As depicted on FIG. 4B, the mixer causes the hot and cold air flows inside of the air guide to intermingle, so that hot air can flow downward from an upper air flow to the rotor blade leading edge 230, and heat the leading edge. Providing at least one mixer in the air flow and having it generate a swirl during the air flow causes the air layers inside of the air flow of the air guide to intermingle, which leads to an improved heat transfer or heat exchange, for example on the rotor blade leading edge.

Alternatively to the aforementioned, heat transfer can also take place at another location of the rotor blade, so that not only the rotor blade leading edge is necessarily heated.

FIG. 5 shows a schematic view of a rotor blade as well as an air guide in the rotor blade according to a fourth exemplary embodiment. The air flow generated by the rotor blade heater can have a first and second air flow 310, 320. For example, the first air flow 310 can comprise an air flow with a hotter temperature, and the second air flow 320 can comprise an air flow with a colder temperature. An aerodynamic mixer 600 can be provided in the rotor blade, and used to mix a laminar or uniform air flow with the first and second air flow 310, 320, for example, by adding a swirl to the air flow. As evident on FIG. 5, the spatial arrangement of the first and second air flow 310, 320 changes along a length 201 of the rotor blade 200. As a consequence, this causes the heat made available by the rotor blade heater 300 in the air flow to better get to those locations at which a heat transfer (i.e., a heating of the rotor blade) is supposed to take place.

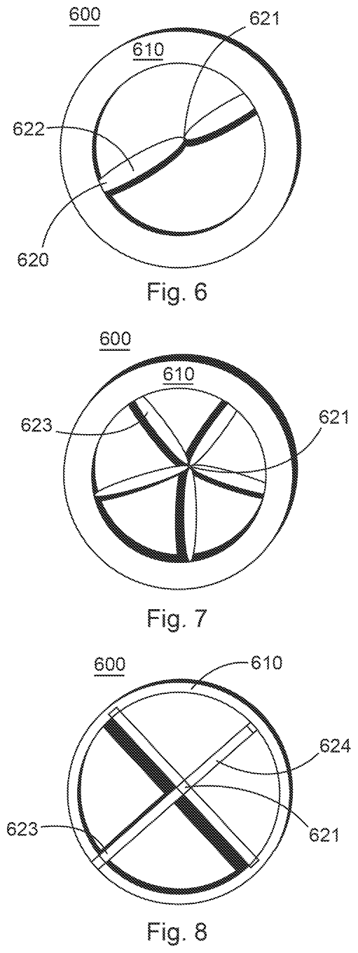

FIG. 6 shows a schematic view of a mixer according to an exemplary embodiment of the disclosure. The aerodynamic mixer 600 has an outer, annular section 610, a midpoint 621 as well as at least one arm 622 inside of the ring 610. FIG. 6 exemplarily shows two arms 622, which meet at the midpoint 621. Alternatively thereto, three, four, five or six arms could be provided.

FIG. 7 shows a schematic view of a mixer according to an aspect of the present disclosure. The aerodynamic mixer 600 has an annular, outer section 610, a midpoint 621 as well as several arms 623, which extend between the midpoint 621 and the ring 610. In particular, FIG. 7 shows five arms. However, the mixer 600 can also have three, four, five or six arms.

FIG. 8 shows a schematic view of a mixer according to an exemplary embodiment of the disclosure. The mixer has an outer ring 610, a midpoint 621 as well as four arms 623, 624, for example.

On FIG. 6, the arms can have an elliptical cross section. On FIG. 7, the arms can likewise have an elliptical design. On FIG. 8, the arms can be straight in design.

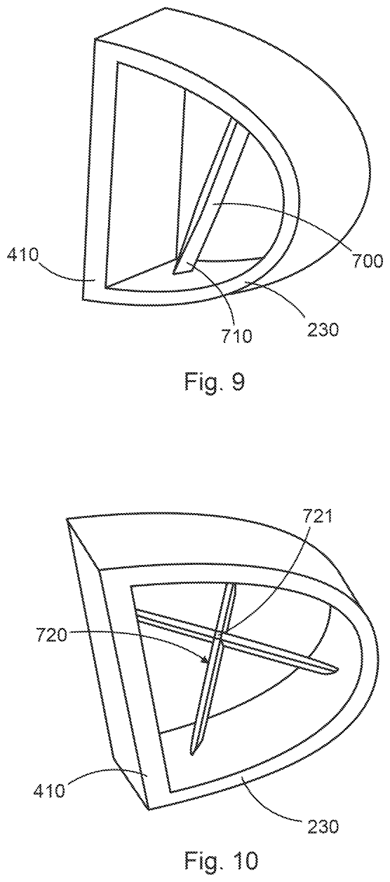

FIG. 9 shows a schematic, sectional view of a rotor blade according to an exemplary embodiment of the disclosure. In particular, FIG. 9 depicts a web 410 as well as a leading edge 230 of the rotor blade, for example. A mixer 700 is provided in the interior volume between the web 410 and the leading edge 230. The mixer 700 can have a guiding element 710. The guiding element 710 can extend between two sections of the leading edge 230. The guiding element 710 can have an oblong design, and its two ends can be internally fastened to a wall of the rotor blade 200.

FIG. 10 shows a schematic, sectional view of a rotor blade according to an exemplary embodiment of the disclosure. Apart from the web 410, FIG. 10 depicts a rotor blade leading edge 230. Further provided is a mixer 700, which has several arms 720 around a midpoint 721. The arms extend to different sections of the rotor blade leading edge. The guiding element 720 can have an oblong design, and its ends can be internally fastened to a wall of the rotor blade 200 or to a web 410.

As a result of the mixer 700, an exemplarily laminar air flow is influenced by the mixer, so that that a swirl is added to the air flow.

FIG. 11 shows a schematic, sectional view of a rotor blade according to a tenth exemplary embodiment. The rotor blade 200 has a rotor blade leading edge 230 and a rotor blade trailing edge, and webs 410 between the suction and pressure sides. According to this exemplary embodiment, the first end 801 of at least one mixer 800 is coupled to one of the webs 410. The mixer 800 is thus only fastened at its first end 801, while the second end 802 is designed as a free end, and protrudes into the interior volume of the rotor blade.

The first end of the mixer can be fastened to an inner wall of the rotor blade or to a web in the rotor blade.

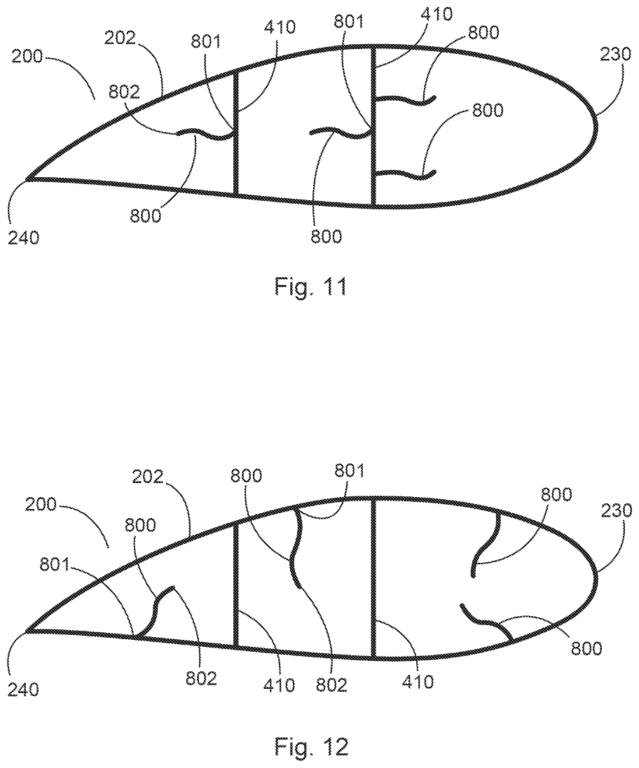

FIG. 12 shows a schematic, sectional view of a rotor blade according to an eleventh exemplary embodiment. The rotor blade 200 has a rotor blade leading edge 230, a rotor blade trailing edge 240 as well as a rotor blade wall 202. The respective first end 801 of the mixers 800 is fastened to the interior of the rotor blade wall 202. The second end 802 is here a respective free end, and protrudes into the interior volume of the rotor blade. The configuration of the mixer according to the eleventh exemplary embodiment is advantageous, because it provides a simple and cost-effective fastening option for the mixer.

According to an aspect of the present disclosure, the aerodynamic mixer 700 can be provided at different locations along the length L of the rotor blade 200 and inside of the rotor blade 200, for example between a web and the rotor blade leading edge 230 or between the web 410 and a rotor blade trailing edge 230.

According to an aspect of the present disclosure, the aerodynamic mixers 600, 700 are used to locally influence an air flow inside of the air guide of the rotor blade.

According to an aspect of the present disclosure, imprinting a swirl on the air flow in the air guide for the rotor blade heater yields a significant improvement in blade heater performance due to an elevated heat exchange on the surface to be heated (for example, rotor blade leading edge).

The aerodynamic mixers can be designed as stators, baffle plates, spiral grooves (e.g., in the inner wall of the rotor blade). These can allow a streamlined design owing to a negligibly small additional pressure loss inside of the flow channel. Additionally generating a swirl in the air flow can thus not necessarily lead to an increase in pressure losses.

This happens because wall pressure losses depend primarily on normal straight lines of the velocity component along the primary direction of flow on the wall due to the surface friction, and not on gradients of the velocity components of the secondary flow (i.e., deflection of the flow by the baffle plates, for example).

The mixer improves how well the flow near the wall being cooled on the surface is mixed with the air flow essentially located in the flow channel, which has a higher temperature. This increases the temperature of the air flow that comes into contact with the wall of the flow channel. As a consequence, the heat transfer to the wall of the rotor blades is significantly improved. This also significantly raises the efficiency of the rotor blade heater, without having to increase the performance of the rotor blade heater.

According to an aspect of the present disclosure, already installed rotor blades can be retrofitted with the aerodynamic mixers according to the invention, so as to increase the efficiency of the rotor blade heater.

The solution according to the disclosure can be used in particular in rotor blades of a wind turbine that have a large length and a smaller inner cross section.

According to an aspect of the present disclosure, using the mixer disclosure makes it possible to significantly improve a temperature of the air flow on the rotor blade shell. While the temperature of the air flow on the shell can already drop to 50° C. in prior art, the aerodynamic mixers can be used to increase the temperature of the air flow on the inner wall significantly, in particular to

An improved heat transfer from the heated air to the material of the shell of the rotor blade can thus be achieved without the pressure losses being raised significantly in the process.

A thermal exchange cooler can thus improve a flow near the wall with a warm flow remote from the wall, without higher pressure losses resulting at the same time. Providing the aerodynamic mixer makes it possible to add a swirl to the air flow, which leads to an improved heat transfer, without at the same time increasing the performance of the rotor blade heater.

As the length of the rotor blade increases, the effect of the aerodynamic mixer can diminish, meaning that the swirl component of the flow can diminish. As a consequence, the flow becomes increasingly homogeneous once again. In order to further improve the air flow, several aerodynamic mixers can thus be provided in the rotor blade, so that these aerodynamic mixers are provided at several locations, and can thereby add a swirl at several locations of the air flow.

According to an aspect of the present disclosure, the aerodynamic mixer can be provided by providing a plurality of spiral grooves on the inner wall of the rotor blade shell. These spiral grooves can be used to add a swirl to the air flow.

According to an aspect of the present disclosure, local constrictions inside of the rotor blade can also be aerodynamically optimized using an aerodynamic mixer. This makes it possible to prevent the flow from separating inside of the rotor blade.

The aerodynamic mixer can be a static or passive mixer. To this end, the mixer optionally has no active or movable parts, so as to mix the air flow or create turbulence.

### REFERENCE LIST

100 Wind turbine
102 Tower
104 Nacelle
106 Rotor
110 Spinner
200 Rotor blades
201 Length
202 Wall
210 Rotor blade root
220 Rotor blade tip
230 Leading edge
240 Trailing edge
250 Pressure side
260 Suction side
300 Rotor blade heater
310 Air flow (hot air)
320 Air flow (cold air)
400 Air guide
410 Web
411 Web
412 Web
600 Mixer
610 Ring
620 Arm
621 Midpoint
622 Arm
623 Arm
624 Arm
700 Mixer
710 Guide element
720 Arm
721 Midpoint
800 Mixer
801 First end
L Longitudinal direction

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A wind turbine rotor blade comprising:
a rotor blade body having a length, a rotor blade root, a rotor blade tip, a pressure side, a suction side, a leading edge, and a trailing edge,
an air guide for heated air to guide heated air inside of the rotor blade and along a longitudinal direction of the rotor blade from the rotor blade root in a direction of the rotor blade tip, and
at least one aerodynamic mixer to influence an air flow in an area of the air guide,
wherein the at least one aerodynamic mixer is a passive mixer or a static mixer.

2. The wind turbine rotor blade according to claim 1, wherein the air guide has at least one web arranged between the pressure side and the suction side, and extends along the longitudinal direction of the rotor blade, wherein the at least one aerodynamic mixer is arranged along the at least one web.

3. The wind turbine rotor blade according to claim 1, wherein the at least one aerodynamic mixer has a ring and at least one arm inside of the ring.

4. The wind turbine rotor blade according to claim 1, wherein the aerodynamic mixer has a baffle plate.

5. The wind turbine rotor blade according to claim 4, wherein at least one baffle plate extends between a section of the rotor blade body or a web.

6. The wind turbine rotor blade according to claim 1, wherein a first end of an aerodynamic mixer is fastened to an inner surface of the rotor blade body or to a web, and a second end the protrudes freely into an interior of the rotor blade body.

7. The wind turbine rotor blade according to claim 1, wherein the aerodynamic mixer is configured to cause turbulence in air flowing therethrough such that air masses with varying temperatures are mixed together.

8. The wind turbine rotor blade according to claim 1, wherein the aerodynamic mixer is configured to cause a local increase in flow rate such that air masses with varying temperatures are mixed together.

9. A wind turbine comprising at least one wind turbine rotor blade according to claim 1.
